(19) United States
(12) Patent Application Publication
(10) Pub. No.: US 2010/0251171 A1
(43) Pub. Date: Sep. 30, 2010

(54) GRAPHICAL USER INTERFACE WHICH ADAPTS TO VIEWING DISTANCE

(76) Inventor: Kenneth A. Parulski, Rochester, NY (US)

Correspondence Address: Peter P. Hernandez, Patent Legal Staff;Eastman Kodak Company, 343 State Street, Rochester, NY, 14650-2201, US

(21) Appl. No.: 12/414,762

(22) Filed: Mar. 31, 2009

(51) Int. Cl. G06F 3/048

(52) U.S. Cl. 715/810

(57) ABSTRACT

A viewing system includes a display screen; a processor for providing pictorial images and a graphical user interface menu to be displayed on the display screen; a user interface control for enabling a user to select particular items from the graphical user interface menu in order to control the pictorial images displayed on the display screen; and means for automatically determining the proximate distance between the display screen and the user; wherein the graphical user interface menu is modified responsive to the proximate distance.

### FIELD OF THE INVENTION

The present invention generally relates to television displays having pictorial images and a graphical user interface menu for controlling the pictorial images and, more particularly, to such television displays that automatically modify the text size or icon size of the graphical user interface menu based on the user distance from the display.

### BACKGROUND OF THE INVENTION

In prior art systems, when designing the image processing for a TV display, an assumption is made about the viewing distance (i.e., the distance between the viewer and the display screen). The sharpening and noise reduction processing used for the display is based on the assumed viewing distance (i.e., a viewing distance of 10 feet). The graphical user interface (GUI) menu, which permits selection of various options, is also designed to be viewed at this assumed viewing distance. A remote control permits the user to select the desired menu item from the graphical user interface menu for altering the display based on the selected menu item. For example, the menu item may permit text of the audio to be displayed for viewers who are “deaf.”

Computer word processing programs, such as Microsoft Word®, have pull-down menus that permit the user to select various “zoom” percentages which alter the size of the displayed document, thereby changing the size of the text and other features of the document being displayed on the display screen of the computer. For example, one hundred percent is the default “normal” text size with options to enlarge up to five hundred percent and shrink down to ten percent. This is a manual user setting, and the user of the computer program must manually change the zoom setting. This is typically done to enlarge the text size in order to be more readable at larger viewing distances.

This illustrates that it is advantageous for the display system to provide user-friendly viewing options. However, the graphical user interface menu for current television displays is a static interface that does not vary in response to the viewing distance. Consequently, a need exists for a graphical user interface that is more user-friendly, and which enables the user to easily discern the GUI text or icons at different viewing distances

### SUMMARY OF THE INVENTION

The present invention is directed to overcoming one or more of the problems set forth above. Briefly summarized, according to one aspect of the invention, the invention resides in a viewing system having (a) a display screen; (b) a processor for providing pictorial images and a graphical user interface menu to be displayed on the display screen; (c) a user interface control for enabling a user to select particular items from the graphical user interface menu in order to control the pictorial images displayed on the display screen; and (d) means for automatically determining the proximate distance between the display screen and the user; wherein the graphical user interface menu is modified responsive to the proximate distance.

It is an object of the present invention to permit variation of the text size of the graphical user interface menu based on the distance between the user and the display screen.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECT OF THE INVENTION

The present invention has the advantage of adapting the graphical user interface menu to the actual viewing situation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of the viewing system of the present invention;

FIG. 2 is a flowchart illustrating the operation of the present invention;

FIG. 3 is an exploded front view of a remote control for use with the viewing system of the present invention;

FIGS. 4a and 4b illustrate a first example of an adaptable GUI using the various text sizes displayable on the graphical user interface menu; and

FIGS. 5a and 5b are illustrations of a second example of an adaptable GUI using a variable number of menu items that are automatically displayed based on the viewing distance.

### DETAILED DESCRIPTION OF THE INVENTION

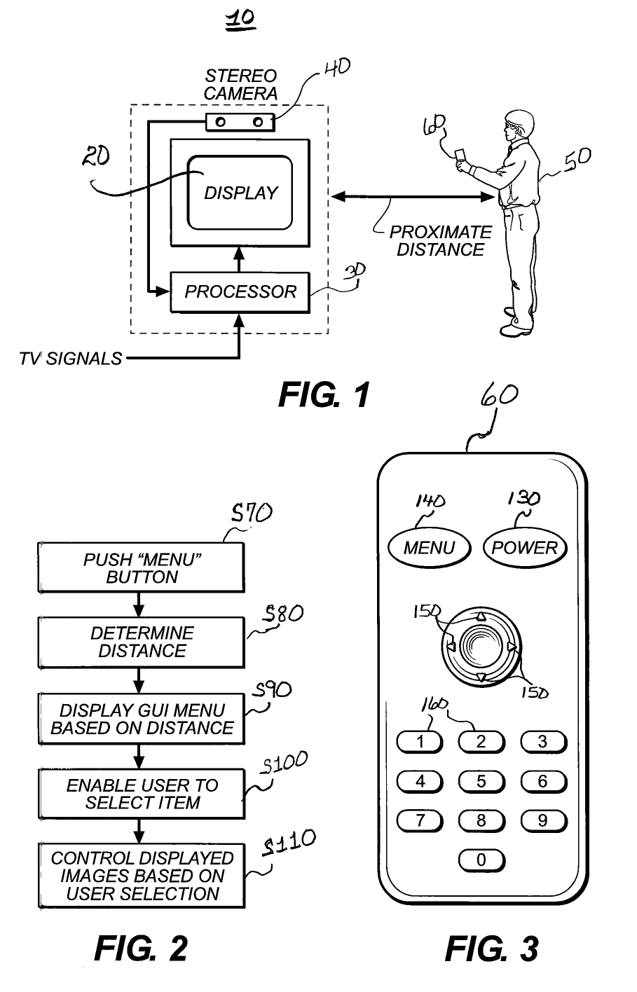

Turning now to FIG. 1, there is shown an overview of the viewing system of the present invention. The viewing system 10 includes a display 20 that displays pictorial images and a graphical user interface menu that permits selection of various display parameters for the pictorial images. The display 20 is shown as a television display in the preferred embodiment, but the display may also be a computer display or the like. A processor 30 receives input signals (preferably TV signals in the preferred embodiment) that represent the pictorial images and generates the graphical user interface menu that is displayed on the display 20. Based on the input signals and the user's selections from the GUI menu, the processor 30 then controls the displayed pictorial images. A stereo camera 40 is used for determining the proximate distance between the display 20 and a user 50 by identifying the locations of the user 50 in the two stereo images, and determining the disparity between the two images. Consequently, the stereo camera 40 is located at the same or substantially the same location as the display 20, or at a fixed, known distance in front of (or behind) the display 20. Although the display 20, processor 30 and stereo camera 40 are shown as separate units, they may be an integrated unit as illustrated by the dashed lines. It is noted that other mechanisms may also be used for determining the proximate distance between the display 20 and the user as will be described in detail below.

The user 50 views the display 20 and manipulates a wireless remote control 60 for controlling the graphical user interface menu displayed on the display 20. The graphical user interface menu permits selection of display parameters for the pictorial images.

It should be noted that a stereo camera is one example of a multi-view camera, which captures a plurality of images of the same scene from a plurality of perspectives. Instead of using a multi-view camera to determine the proximate distance, other methods can be used. For example, the wireless remote control 60 can include an emitter and detector pair, such as a laser emitter and detector, or an ultrasonic emitter and detector, that can be used to determine the proximate distance between the user 50 and the display 20, as is done using laser tape measurement devices and ultrasonic distance measurement devices. The wireless remote control 60 then transmits the distance information wirelessly to the processor 30.

Referring to FIG. 2, there is shown a flowchart illustrating the steps involved in operating the present invention. First, the user 50 pushes the “menu” button S70, and then the means for automatically controlling the proximate distance determines the proximate distance S80 between the user 50 and the display 20, which proximate distance is transmitted to the processor 30. The processor 30 then directs the display 20 to display the particular graphical user interface menu S90 that is based on the determined proximate distance. The user 50 uses the remote control 60 to select the desired menu function S100. Based on the selected menu item, the display 20 displays the pictorial images in the selected format S110. The menu item can be such functions as text and/or icons corresponding to TV program selection (e.g. channel guides and channel selection), picture adjustments (e.g. contrast, color saturation), audio (e.g. volume, mute) and the like.

Referring to FIG. 3, there is shown an exploded front view of the wireless remote control 60. A “power” button 130 permits the user to turn the remote control “on” and “off.” The “menu” button 140 permits the user to display the graphical user interface menu with its various options. The triangular arrowhead buttons (▴, [symbol] , ▾, and [symbol] ) 150 permit the user to move the highlighted area on the display (in the direction the particular triangular arrowhead button is pointing) so that the desired menu item can be highlighted for selection. In lieu of using the triangular arrowhead buttons 150, the remote control 60 includes “numbered” buttons 160 that correspond to a menu item “number” for permitting selection of a particular menu item.

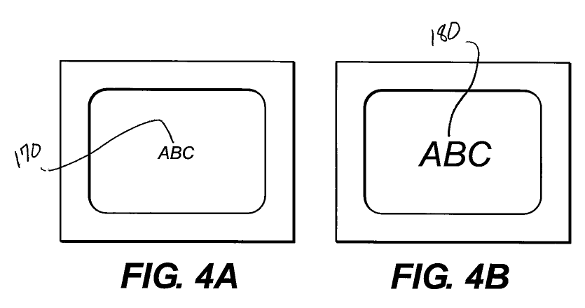

Referring to FIGS. 4a and 4b, there are illustrated different text sizes used for the graphical user interface menu for different proximate distances. In FIG. 4a, there is shown smaller text size 170 when the viewer or user is close to the display 20, and the proximate distance is relatively small. In FIG. 4b, there is shown a larger text size 180 when the viewer or user 50 is far away from the display 20, and the proximate distance is relatively large. While not shown in the figures, the menu can include icons instead of, or in addition to, the text. While only two different text sizes are shown in FIG. 4, it is understood that a larger number of different text sizes (e.g. four or more different text sizes) would normally be used, for a corresponding number of proximate distances (e.g 2 foot, 4 foot, 8, foot, and 16 foot distances)

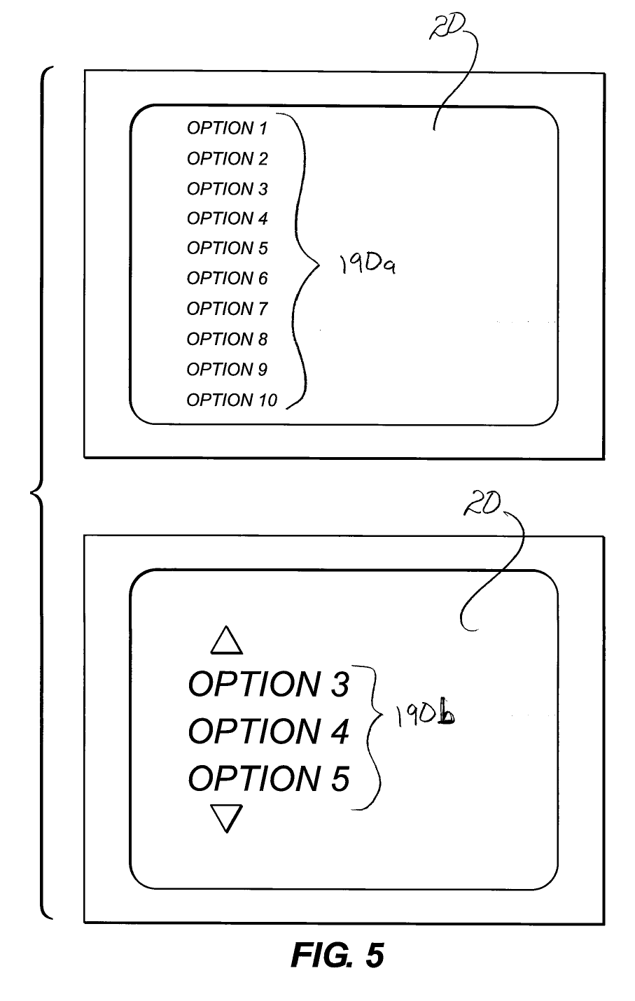

Referring to FIGS. 5a and 5b, there are shown the two graphical user interface menus 190a and 190b used for two different proximate distances. The two different menus 190a and 190b display a different number of menu options on the display 20 at a given time. Referring to FIG. 5a, when the user 50 is “close” to the display 20, and the proximate distance is relatively small, a relatively large number of menu items (e.g. ten menu items) is displayed at the same time on the display 20. In FIG. 5a, any one of the ten items is available for immediate selection by highlighting the desired item via the remote control 60. Alternatively, when the user 50 is “far away” from the display 20, and the proximate distance is relatively large, then as shown in FIG. 5b, only a partial menu of the available menu items 190b (three in the preferred embodiment) is displayed for immediate selection. The triangular arrowhead buttons (▴ and ▾) 150 permit the user 50 to press the particular triangular arrowhead button 150 on the remote control 60 for scrolling a “window” upwardly or downwardly for displaying the next menu item not currently shown along with the last two options. For example, if the upward triangular arrowhead 150 is pressed, options 4, 5 and 6 are displayed, and option 3 is removed from the display “window.” It is noted that the text size in FIG. 5a is much smaller than the text size in FIG. 5b since FIG. 5a is configured for when the user is close to the display.

The invention has been described in detail with particular reference to certain preferred embodiments thereof, but it will be understood that variations and modifications can be effected within the spirit and scope of the invention.

### PARTS LIST

10 viewing system
20 display
30 processor
40 stereo camera
50 user
60 wireless remote control
130 “power” button
140 “menu” button
150 triangular arrowhead buttons
160 “numbered” buttons
170 smaller text size
180 larger text size
190a graphical user interface
190b graphical user interface

1. A viewing system comprising:
(a) a display screen;
(b) a processor for providing pictorial images and a graphical user interface menu to be displayed on the display screen;
(c) a user interface control for enabling a user to select particular items from the graphical user interface menu in order to control the pictorial images displayed on the display screen; and
(d) means for automatically determining the proximate distance between the display screen and the user; wherein the graphical user interface menu is modified responsive to the proximate distance.

2. The viewing system as in claim 1, wherein text size used for the graphical user interface menu is modified.

3. The viewing system as in claim 1, wherein a number of items simultaneously displayed on the graphical user interface menu is modified.

4. The viewing system as in claim 1, wherein the means for automatically determining the proximate distance is a multi-view camera coupled to the processor.

5. The viewing system as in claim 4, wherein the multi-view camera is a stereo-camera.

6. The viewing system as in claim 1, wherein the user interface control is a wireless remote control.

7. The viewing system as in claim 6, wherein the means for automatically determining the proximate distance includes an emitter in the wireless remote control.
